(19) United States
(12) Patent Application Publication
(10) Pub. No.: US 2016/0259955 A1
(43) Pub. Date: Sep. 8, 2016

(54) DISPLAY SYSTEM AND METHOD

(71) Applicant: ICONEME LTD, London (GB)

(72) Inventors: Jonathan Andrew Berlin, Greater London (GB); Adrian Brian Coe, Greater London (GB)

(21) Appl. No.: 15/033,294

(22) PCT Filed: Nov. 6, 2014
(86) PCT No.: PCT/GB2014/053310

§ 371 Date: Apr. 29, 2016

(30) Foreign Application Priority Data
Nov. 6, 2013 (GB) 1319622.5

(51) Int. Cl. G06K 7/10; G06Q 30/02

(52) U.S. Cl. CPC G06K 7/10415; G06Q 30/0242

(57) ABSTRACT

A display window (10) displays items of merchandise in association beacon apparatus (22). The merchandise is provided in Association with display furniture (12) that supports the beacon apparatus (22). The beacon apparatus (22) is short range and carries (24) product and location codes (28, 30) together with app activation codes (26) that cause the portable device (16) to activate an app. The app receives all of the beacon information (24,26, 28,30) and transfer them to an app server which response by providing product outlines to the portable device (16), that enables selection of an item of merchandise for interaction with the app server. A single short range beacon apparatus (22) can provide information for a plurality of items of merchandise. The app server stores all of the beacon (22) location codes and selected product indication codes (30) as statistical evidence of customer preference. The app server permits purchase of items. The short range radio link is preferably provided by Bluetooth (registered trademark).

### FIELD OF THE INVENTION

The present invention relates to an apparatus and a system suitable for use in association with a retail display. It more particularly relates to keeping tally of visitors who are “window shopping”. It further relates to access to particular selected goods even though the retail outlet may be closed.

### BACKGROUND TO THE INVENTION

It is well-known for individuals passing by a retail outlet to indulge in “window shopping”. During times when the retail outlet may be open, the passer by may not have time to enter the retail outlet in response to an item seen in a display window. At other times when the retail outlet may be closed, a passer by may be attracted by an item in the window.

When an item is on display within a retail store, a customer may not have time to make an enquiry concerning the article which has aroused the interest.

In order to plan stock levels it is important for a retail outlet operator to learn what items are of interest to the purchasing public. With all probability, under the present provisions, a retail outlet operator is unlikely to learn of the true numbers of persons interested in each article. Whenever a potential customer is prevented from making an enquiry in the retail outlet or from purchasing an item, the operator of the retail outlet will not know of potential customer interest. Such indications of interest are lost.

European patent application EP2603115 (A1) discloses a mannequin provided with a video camera that is hidden and connected to a processing system capable of determining, for statistical purposes, age, gender and ethnic group of those people who enter the field of action of the video camera. While this European patent application may keep track of the numbers and types of individuals looking into a display window, it lacks the ability to know which item in the display window each observer was in fact interested in. The present invention seeks to provide more definite data.

International patent application WO2013020146 (A2) discloses a “Virtual Salesman” in the form of a the combination of a virtual mannequin, which is a Plexiglass or any transparent material cut-out, that has a special projection foil stuck on the back which turns it into hi-resolution projection screen. A pre-recorded video of an actor/actress or animated character is then projected onto the cut-out, this creates a lifelike video image. There are speakers for sound, either built into the kiosk or in the booth construction. The Virtual Salesman combines this to a touch screen kiosk or touchscreen with an interface having user selectable options, each option having a moving image and or verbal command associated with the option selected on the touchscreen or touchscreen kiosk. The Virtual Salesman reacts to the option selected on the touchscreen or touchscreen kiosk through visual and verbal recordings on the cut-out virtual mannequin. While that solution may be applicable to this sale an explanation of goods within a retail outlet, the fact that, when window shopping, it would be shielded from sound and/or touch by the display window glass renders it ineffective for a window shopping customer. It also causes the presence of undesirable additional items in a display window that reduces the number of items that can be displayed and may be aesthetically displeasing. The present invention seeks to overcome these problems and even to allow simple purchase during window shopping.

Another problem that arises when window shopping is the inability to gain more information about items of interest. This would involve, at the very least, guessing an identity for the item of interest, accessing the Internet website relating to the retail outlet, and then searching for and perhaps (and perhaps not) finding the item. The act of window shopping is generally of a casual nature, that is rendered not casual by the processes necessary to discover the identity and the details of an object. There is also uncertainty where the object, if indeed it has been correctly identified, was viewed, if indeed it was not found by an Internet search. The footfall and interest data for the particular retail outlet is thereby confused and rendered most uncertain. The present invention seeks to provide certainty for such data.

It is known to include transmitting reading devices within a window display mannequin. For example, United States patent U.S. Pat. No. 8,215,552 (B1) discloses a housing for concealing a RFID system is provided including one or more radio frequency antennas, one or more RFID readers, and a central frame. The central frame is attached and concealed within body of a store mannequin providing an exterior shell that is aesthetically pleasing and that can be dressed in store merchandise, thus advertising the store goods and protecting the structure from damage. The reader can receive product data from nearby tags. Numerous other examples are known whereby RFID transmitters and readers are provided in a retail environment. RFID devices are of extremely limited range. They also fail to offer any more than item identifying facilities when, indeed, they can be accessed. The present invention seeks to provide means whereby limited range communication can be provided from display items through the display window to talk to a communication device in the possession of the window shopper.

### SUMMARY OF THE INVENTION

According to a first aspect, the present invention consists in a system comprising:

a short range beacon adapted to be provided in association with an item of merchandise on display;

a network enabled portable device operable to receive signals from the short range beacon and further operable to execute an app allowing network access;

an app server within the network operable to respond to input from a portable device;

where

the short range beacon is operable to transmit code enabling the portable device to execute the app;

the portable device is operable to monitor short range signals and further operable to execute the app if enabling code is received;

and where

the short range beacon is further operable to transmit code identifying the item of merchandise in association with which it is provided;

the portable device is operable to receive the merchandise identifying code and to pass the merchandise identifying code to the app server;

and

the app server is operable to obtain information concerning the identified merchandise and to provide interaction with the portable device.

According to a second aspect, the present invention consists in a method comprising the steps of:

a step of providing a short range beacon in association with an item of merchandise on display;

a step of providing a network enabled portable device to receive signals from the short range beacon and to execute an app allowing network access;

a step of providing an app server within the network to respond to input from a portable device;

including the further steps

a step of the short range beacon transmitting code enabling the portable device to execute the app;

a step of the portable device monitoring the short range signals and executing the app if enabling code is received;

a step of the short range beacon transmitting code identifying the item of merchandise in association with which it is provided;

a step of the portable device receiving the merchandise identifying code and passing the merchandise identifying code to the app server;

and

a step of the app server obtaining information concerning the identified merchandise and providing interaction with the portable device.

The invention also provides that the short range beacon can also operable to transmit information relating to the location of the short range beacon; and wherein the app server can be operable to store information concerning at least one of: the location of the short range beacon; and the merchandise identifying code.

The invention also provides that the merchandise can be displayed in a display window.

The invention also provides display furniture, the merchandise being displayed proximately to the display furniture and the display furniture supporting the short range beacon.

The invention also provides that the display furniture can comprise at least one of: human form mannequins; one or more portions of human form mannequins; display stands; garments stands; display screens; shelves; and cupboards.

The invention also provides that the short range beacon can be supported on or in the item of display furniture.

The invention also provides that the short range beacon can be adapted to be provided in association with a plurality of items of merchandise on display; and that the short range beacon can be operable to transmit code identifying the each of the plurality of items of merchandise in association with which it is provided.

The invention also provides that there can be a plurality of short range beacons; and that the portable device is operable to receive the merchandise identifying codes from each of the plurality of short range beacons and to pass the merchandise identifying code to the app server.

The invention also provides that the app server can be operable to provide to the portable device outlines of each of the plurality of items of merchandise in association with which the short range beacon is provided; and that the portable device can be operable to provide plural merchandise item selection indication to the app server.

### BRIEF DESCRIPTION OF THE DRAWINGS

The invention is further described, by way of examples, by the following description to be read in conjunction with the appended drawings, in which:

FIG. 1 illustrates one environment in which the present invention can be used.

FIGS. 2a to 2d show an exemplary mannequin or mannequin parts with short range beacon.

FIG. 3 shows an exemplary beacon message sent by the beacon apparatus to be received by the portable device.

FIG. 4 provides an exemplary layout of the contents of a portable device that would fulfil the minimum requirements for use with the present invention.

FIG. 5 provides an exemplary elaboration of the Internet portion of FIG. 1.

FIG. 6 is an exemplary flow chart illustrating possible behaviours of the portable device and the responses of the app server during operation of the invention.

FIG. 7 is a diagrammatic representation of the process and architecture of the interaction between the beacon, the mobile device and the remote processing system.

and

FIGS. 8 to 14 are possible displays provided on the mobile device during some of the process described in FIG. 7.

### DETAILED DESCRIPTION

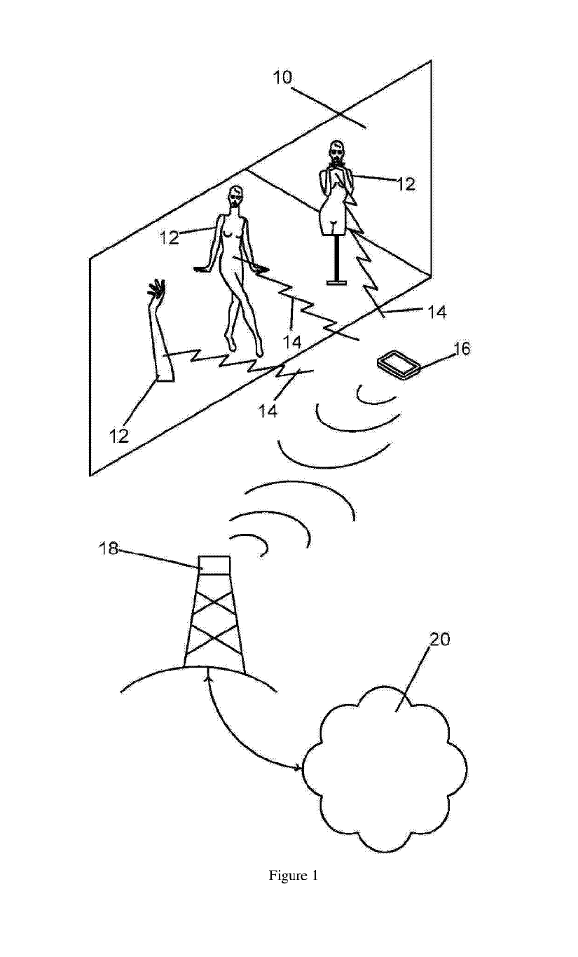

Attention is first drawn to FIG. 1, illustrating one environment in which the present invention can be used.

A shop display window 10 displays one or more mannequins and display fitments 12 where on goods offered on sale (not shown) are displayed. Each mannequin and display fitments 12 emits a short range radio beacon signal 14 which can be picked up by a portable device such as a smart phone 16 carried by a passerby as they pass the shop display window 10.

The portable device 16 is in turn in bidirectional communication employing, for example, 3G or 4G technology (or any other smart phone wireless technology that may come to be employed) with a cellular mast 18 that provides for the portable device to enjoy bidirectional communication with the Internet.

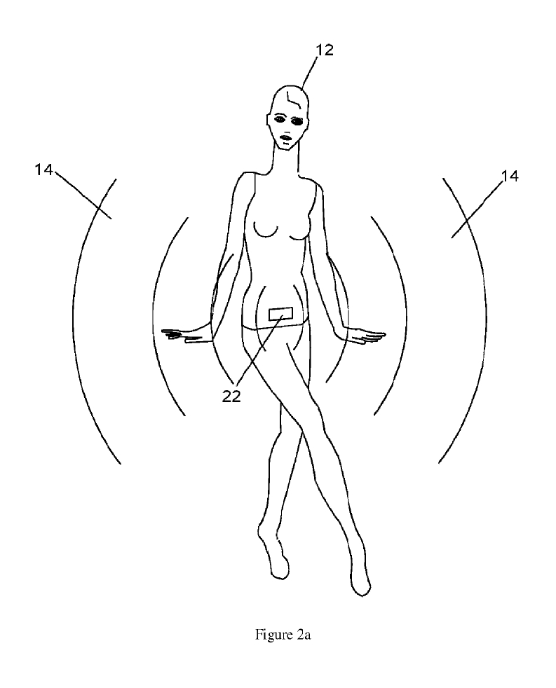

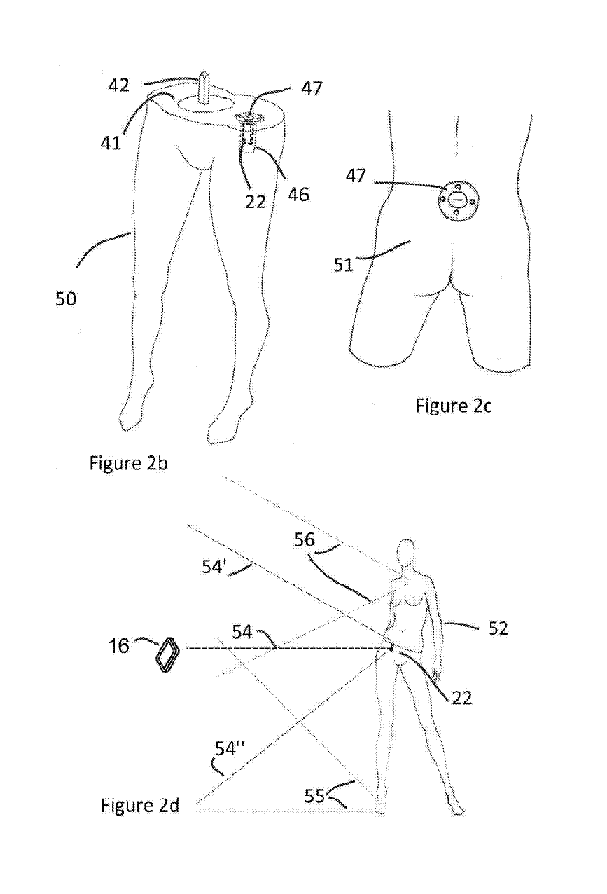

Attention is next dawn to FIG. 2a, showing an exemplary mannequin. The mannequin 12 is provided with a beacon apparatus 22 that continuously emits a signal, which as will be shown later, can selectably activate a portable device 16 activation signal that can activate an “App” within the portable device 16 to interact with the items shown in FIG. 1. An “app” is, throughout the present description, defined as a selectably activatable gateway computer program that can initiate communication with and interact with Internet items such as servers and databases that relate to the information provided by the beacon apparatus 22.

The beacon apparatus 22 is preferably contained within an aperture within the mannequin 12, and is preferably closable so as not to disturb the outline of the mannequin 12. The overall mannequin 12 is preferably manufactured from nonconductive materials that allow through passage of radio signals provided by the beacon apparatus 22. Different mannequins 12 can have the beacon apparatus 22 provided at apertures on different parts of the mannequin 12 dependently upon what sort of garments a particular mannequin 12 is intended to display.

Referring to FIG. 2b, the mannequin may be formed of lower body section 50 and a separable upper body section (not here shown), which join at the waist, the lower body section having an upwardly pointing pin 42 located approximately at the centre of the upper surface 41 of the lower body section 50. A compartment 46 for housing the beacon 22 is conveniently located to one side of the pin 42, with a cover 47 which may be screwed down or otherwise secured to close the opening of the compartment 46 in the upper surface 41. The securement of the cover is ideally tamperproof, for example security screws may be used, or some locking means.

An upper body section is then placed upon the lower body section 50, with the pin 42 locating in a corresponding socket on the upper body section. This further secures the beacon 22 in the compartment 46, as the cover 47 is not accessible without dismantling the mannequin.

The mannequin is predominantly composed of plastic, fibre-glass or other composite material that is substantially transparent to radio frequencies, so as to not interfere with the broadcast signal. Metal parts in the mannequin are kept to a minimum and situation away from the compartment, in order to avoid interference or attenuation, and non-metallic finishes or paints are used on the mannequin.

Referring to FIG. 2d, the compartment that houses the beacon 22 in a full body mannequin 52 is oriented so that the beacon's signal is principally broadcast in a region between an upper transmission beam 54′ and a lower transmission beam 54″ (in three dimensions, these beams will be conic), with the strongest signal usually being in a horizontal plane (indicated by line 54) and with minimal transmission along the vertical axis of the mannequin. In this instance, the compartment is aligned essentially along the mannequin's longitudinal axis. This positioning and orientation has been found to optimise the signal strength available to consumers holding a mobile device while walking in a store, or outside a window where the mannequin is displayed.

For a full body mannequin, it has been found that positioning the beacon in the waist gives an optimal signal strength allow a reasonable signal in the range of 2 m to 10 m. Beacons positioned closer to the head or to the feet were subject to attenuation, believed to have been caused by the structure of the mannequin head and the reinforcement components in feet of the mannequin. Further, the transmission regions 55, 56 from the feet and the head are vertically displaced from the usually region that a consumer would be holding their portable device 16.

Where the display form is not a full body mannequin but a mannequin part, other locations must be provided for the beacon. For example, referring to FIG. 2c, where the mannequin is a torso 51, the compartment 46 for the beacon may conveniently be located at the back of the torso in the lumbar region, with the cover 47 opening on the back surface. Here, the mannequin is design to be displayed in a prone position, so the compartment is oriented along the sagittal axis.

A beacon could also be housed other partial mannequins, such as individual heads, arms, or legs, the opening of the compartment for the beacon conveniently being situated on the flat surface.

The beacon apparatus 22 can be powered by battery, or by a concealed power cord. The short range radio signals are preferably short range Bluetooth (registered trademark) signals, but are not limited thereto and can comprise any short range radio signal capable of carrying beacon information and of being received and deciphered by the portable device 16.

Ideally, the beacon is a Bluetooth low energy device. Such a device can transmit a signal while powered by a battery that does not require replacement or maintenance for several years. This eliminates unsightly power cords, which limit the transportability and siting of the mannequin, while providing a useful signal broadcast range. The efficiency of the Bluetooth low energy device allows a small and lightweight battery to be used, so that the mannequin remains lightweight and portable.

A beacon apparatus 22 is hereinbefore and hereinafter defined as a radio transmitting apparatus that operates on a continual basis emitting beacon singles either repeatedly without break or at regular intervals, without requirement for any other radio frequency field to be applied.

Beacons are thus unlike RFID devices, where an interrogating device requires to apply an external radio frequency field to activate the RFID device. The beacon apparatus 22 offers the technical advantage that monitoring alone is sufficient to ensure reception.

The present invention is not restricted to mannequins 12, but can also include display stands of all sorts and styles adapted to display an extensive library of different types of goods. All that is required is for a beacon apparatus 22 to be provided in association with goods on display.

Although items of merchandise on display are shown in a display window 10, it is to be understood that the invention also extends to use for items displayed within a store or facility where a passerby can carry a portable device 16 to a position within the store approximate to the beacon apparatus 22 deployed in association with items of display merchandise.

Although FIG. 2 shows the beacon apparatus 22 being concealed within an aperture on the mannequin 12, it is to be understood that many different manners of attachment of a beacon apparatus 22 are accommodated by the present invention. The beacon apparatus 22 can be attached, for example, on the exterior of a display item by attachment bands, studs or similar items. Equally, the beacon apparatus may be attached on the outside of a display stand away from the shop window 10 so that passers-by will not see the beacon apparatus 22. Another alternative, where the item on sale itself provides concealment, such as a bag or rucksack, the beacon apparatus 22 can be placed there in. The different items of merchandise and beacon apparatus 22 support are hereafter referred to as display furniture.

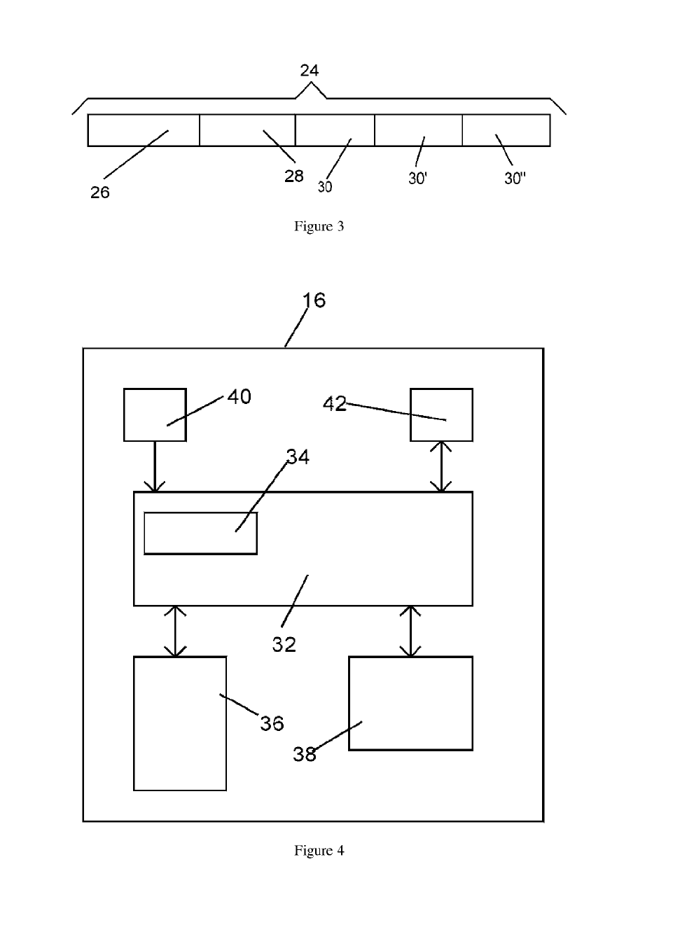

Attention is next drawn to FIG. 3, showing an exemplary beacon message 24 sent by the beacon apparatus 22 to be received by the portable device 16.

An app activating portion 24 carries code that can be recognised by the output in the portable device 16. If the app activation code is contained within the app activation portion 26 of the beacon message, the app activates and commences communication and interaction with the Internet portions shown in FIG. 1.

A display window location indicating portion 28 contains a unique code that identifies which display shop window 10 the short range beacon apparatus 22 occupied. The code contained within the display window location indicating portion 28 can uniquely indicate a store, or a face of a store, or a particular window within a store. When used by the app and its associated Internet 20 features, it provides the unique location being viewed by the passerby.

A merchandise identifier portion 30 provides a unique identifying code for identifying the particular item of merchandise with which the beacon apparatus 22 is associated. When passed on by the portable device 16 to the associated Internet 20 features accessed by the app, the particular goods are identified.

When a portable device 16 is activated by receiving an app activating portion 26 on the short range radio signals 14, it is unlikely that there will be only one beacon apparatus 22 located within the display shop window 10.

A beacon apparatus, in one alternative, can be made to provide merchandise identification for more than one item of displayed merchandise by providing further merchandise identifier portions 30′ 30″ that can be sent through the app activated portable device 16 to the associated Internet 20 features accessed by the app.

As a further alternative, only a single beacon apparatus 22 need be provided within the display shop window 10, sending a beacon message 24 containing a separate merchandise identifier portion 30 30′ 30″ for each item of merchandise on display in the display shop window 10.

Attention is next drawn to FIG. 4, an exemplary layout of the contents of a portable device 16 that would fulfil the minimum requirements for use with the present invention.

The portable device 16 comprises a portable device processor 32 having memory comprising an app program 34. A display screen 36 displays operations of the portable device 16 processor 32 and can also act as an input pointing device for the portable device processor 32. A portable device memory 38 provides the necessary memory capacity for operating the portable device processor 32. A short range receiver 40 is operable to receive signals from the beacon apparatus 22. A wireless communication transceiver 42 enables bidirectional communication between the portable device 16 and the cellular mast 18 to access the Internet 20.

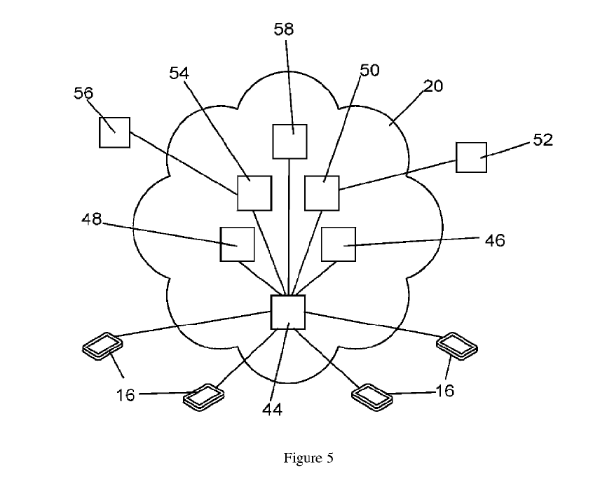

Attention is next drawn to FIG. 5, an elaboration of the Internet 20 portion of FIG. 1.

One or more portable devices 16 from one or more locations can bidirectionally couple to an app server 44. The app server 44 exists in a cloud relationship with various other Internet 20 entities.

A database 46 stores all the information relating to display sites and their locations, merchandize identification indicators 30, and the related Internet information for each indicated merchandise identifier 30.

An SKD server 48 also cooperates with the app server 44 and the database 46. An administrator web portal 50 allows access to one or more administrator clients 52. A display web portal 54 allows access to one or more display clients 56. Third-party application software 58 is also available.

The elements 46-58 all co-operate and assist in enabling the app server 44 to respond to a portable device 16.

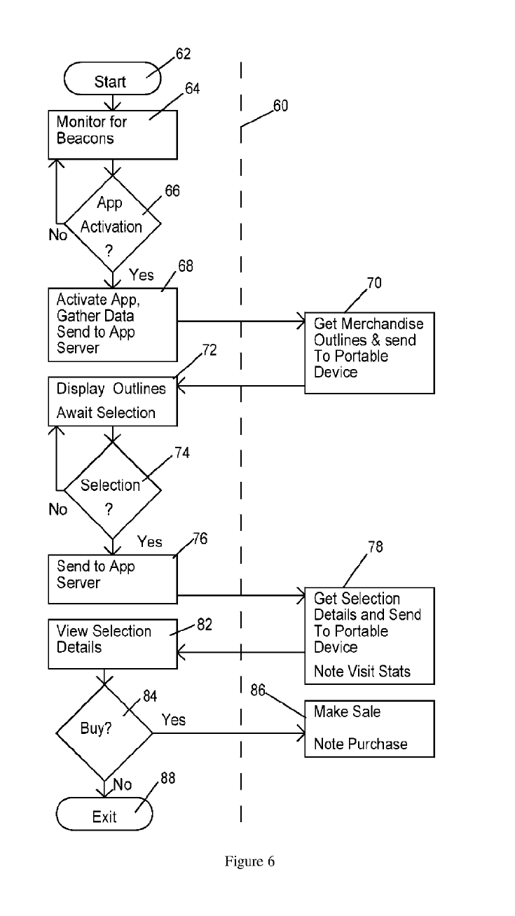

Attention is next drawn to FIG. 6, an exemplary flow chart illustrating possible behaviours of the portable device 16 and the responses of the app server 44 during operation of the invention.

In FIG. 6, the operations of the portable device 16 are shown to the left of broken vertical line 60 and operation of the app server 44 are shown to the right of vertical broken line 60.

From a start 62 a first operation 64 has the portable device 16 continuously monitoring the short range receiver 40 to determine whether and app activation portion 26 is being received. The first operation 64 continues to monitor the short range receiver 40 until a first test 66 detects that an app activating portion 26 of beacon message 24 has been received.

A second operation 68 then activates the App in the portable device and contacts the app server 44. The portable device 16 gathers all of the one or more beacon messages 24 which it receives and sends the whole lot to the app server 44.

The downloaded beacon messages may specify one or more different items of merchandise. In a third operation 70 the app server 44 receives the beacon messages, retrieves outlines of the specified items of merchandise, and sends the merchandise outlines to the portable device 60.

The portable device 16, in a fourth operation 72, displays the merchandise outlines on the portable device 16 display screen 36 and awaits the user to make a selection of one or more of the one or more items specified in the collection of beacon messages 24.

When a second test 74 detects that the user has made a selection, a fifth operation sends indication of the selected item (s) of interest to a sixth operation 78 in the app server 44. The sixth operation 78 as the app server 44 obtain comprehensive details of the selected items of merchandise. The sixth operation 78 also notes and stores the contents of the one or more beacon messages 24 relating to the selected items of merchandise so that a record can be established and maintained of the results of window shopping visits. The sixth operation 78 then sends the retrieved selected merchandise details to a seventh operation 82 in the portable device 16.

The seventh operation 82 as the portable device 16 display the selected one or more items of merchandise that are of interest.

If the third test 84 finds that the user of the portable device 16 desires to buy a selected item of merchandise, an eighth operation 86 has the app server 44 conduct the sale. The eighth operation also notes that the sale has been made because of window shopping and the identity of the item and its location and circumstances are recorded.

If the third test 84 finds that the use of the portable device 16 does not desire to purchase a selected item of merchandise, the third test 84 passes operation to an exit 88 and the portable device 16 closes contact with the app server 44 and returns to the first operation 64.

The flowchart of FIG. 6 is given merely by way of example. Those skilled in the art will be aware that there are many variations and modifications that can be applied without deviating from the invention as claimed.

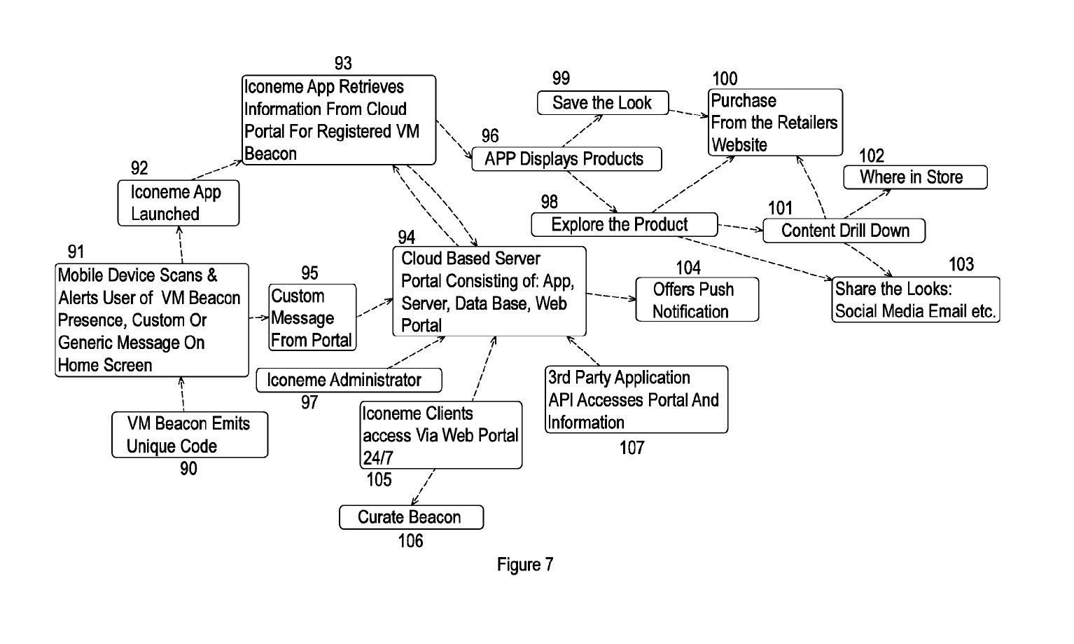

Referring to FIG. 7, in another embodiment of the process, the beacon emits a unique code 90. As previously described, this may include identifies relating to the products associated with the mannequin, and a store identifier, but it may simply be a unique ID associated with that particular mannequin and beacon, registered with the system.

A mobile device belonging to a user such as a potential purchasers is continually scanning for signals at the relevant frequency, and checking the format of signals it receives. When it receives the signal from being emitted by the beacon 90, it alerts the user by generating a message on the mobile device, allowing the user to authorise the interactive application (here designated the ‘Iconeme app’) 91. The user may then confirm the launch of the application 92.

The mobile device then connects to web portal, whose resources may be distributed on remote servers (i.e. a cloud portal) 93, and interrogates a network of cloud based servers and databases 94 for information and instructions relating to the registered beacon ID. Confirmation or interrogation feedback may be provided in a manner invisible to the user, to complete this step.

Either as part of the initial interaction, or immediately afterwards, the cloud portal can send customised messages (based either on the mannequin or the location of the mannequin) to the user to be displayed on the mobile device. For example, messages welcoming the user to the store or a particular section or department may be provided.

The cloud portal 94 may be maintained and updated by an administer 97, particular in terms of the functionality provided, while the content will largely be maintained by the providers of the stores and products 105 who can access at least portions of the cloud portal in order to update and change data, in particular what data is to be provided with a particular beacon 106.

Once the beacon ID has been identified, a message may be sent back to mobile device. The beacon ID will have associated with it specific data such as the products currently being displayed on the mannequin, as well as the store and location data, retrieved by the cloud based portal services 94. In particular, the cloud based server portal 94 can offer a push notification 104, such as an advert, special offer or other discount 109 shown in FIG. 9, associated with the mannequin, though other data may also be used to determine which push notification is displayed, such as specific user data that the app may supply to the cloud based server portal 94.

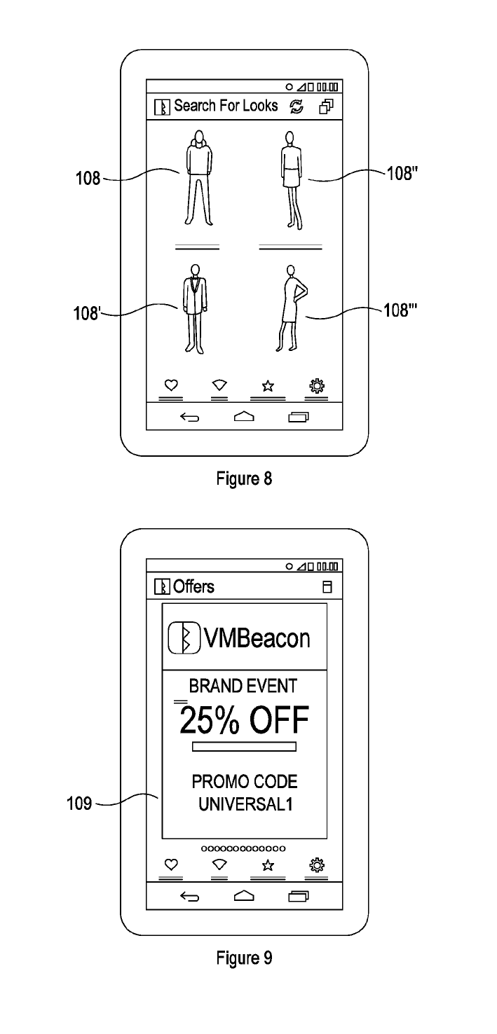

One of the important functions of the app that either occurs automatically or on prompting by the user, is that the products currently being displayed by the mannequin are then shown 96 to the user on the portable device.

Where the mobile device is within range of several mannequin beacons and receives a unique ID from each mannequin beacon, the records associated with each beacon can be retreived and displayed, as shown in FIG. 8 where the products are displayed on four mannequins 108, 108′, 108″, 108′″ shown on the display screen 110 of the user's portable device.

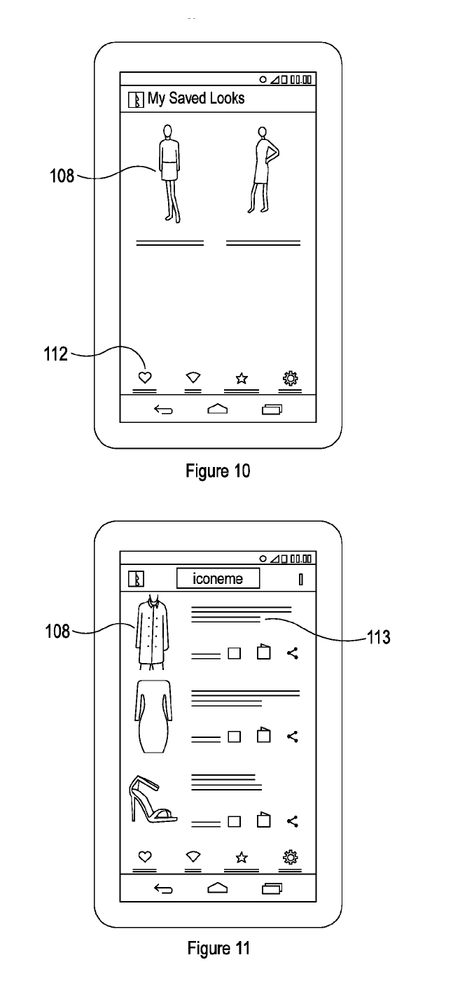

Referring to FIG. 10, one or more of the display screens of the app may include a set of icons 112 which perform particular functions, including an icon allowing the user to save a particular product or group of products 99 for later retrieval and comparison. Another icon may provide a means for the user to communicate 103 his interest to friends through social media, such as posting a notification on platforms such as Facebook (registered trade mark) and Twitter (registered trade mark) together with links to the product concerned.

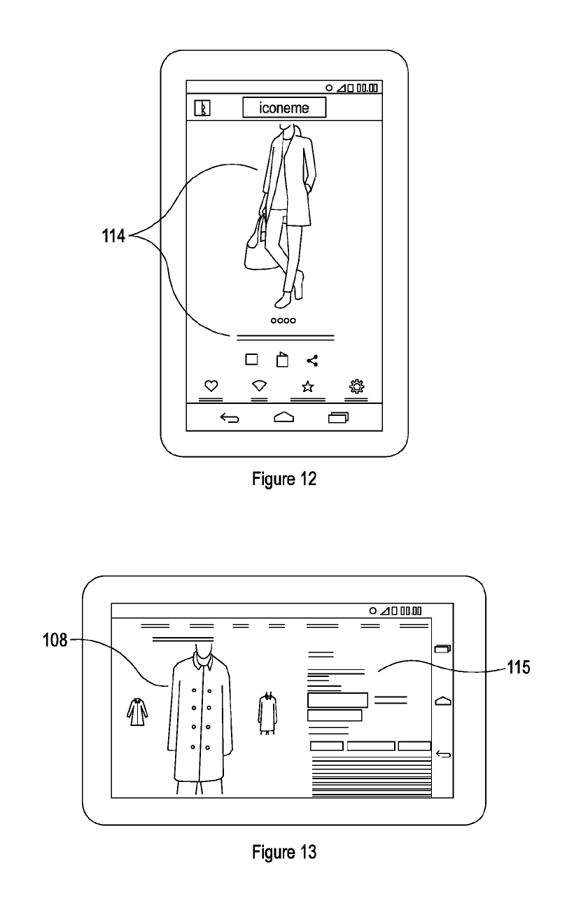

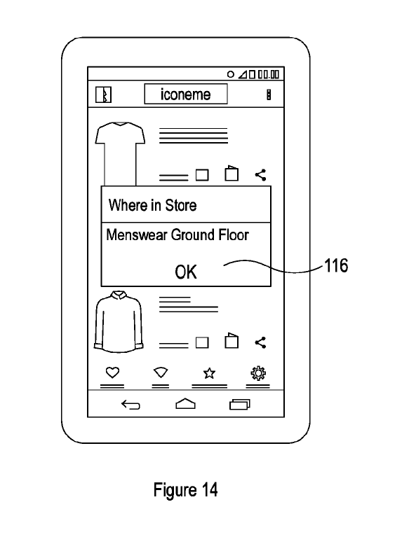

Whenever one or more products 108 are being displayed, the user has the ability to bring up 98 the details 113 associated with of a group of products 108 as shown in FIG. 11, or display 101 the details 115 for a single product 108 alone as shown in FIG. 12. Where a groups of products for each mannequin is displayed as in figure 8, the user may chose a particular mannequin product group 108, 108′, 108″, 108′″ and then explore each item on the mannequin.

Generally, whenever a product or products is being displayed, a simple means of navigating to a virtual check-out area 115 is provided 100, whether to buy a single selected product, or a list of products saved in a basket.

Since the mannequin ID can be used to identify the store in which it is being displayed, when the user is interested in a particular product, they can request 102 that its location in the store is shown, and the cloud based portal services 94 can retrieve this for the app to display to the user 116.

It is to be appreciated that the invention has he been described by way of example relating to display of garments, and other items of general clothing interest. It may also be applied to related items such as jewellery and accessories such as handbags, and other items that may be displayed on or around mannequins.

In fact, the invention can be applied to this sale and expression of interest in any field of sale or retail, including all fields of endeavour where an item may be placed in a display window on offer for sale.

The invention has been described, so far, in terms of items of merchandise on display in a display window 10. It is to be understood that the invention also extends to use for items displayed within a store or facility where a passerby can carry a portable device 16 to a position within the store approximate to the beacon apparatus 22 deployed in association with items of display merchandise.

The invention is further more precisely defined by the following appended claims.

1-14. (canceled)

15. A system comprising:
a mannequin or portion of a mannequin fitted with a short range beacon and to be provided in association with an item of merchandise on display
a network enabled portable device operable to receive signals from the short range beacon and further operable to execute an app allowing network access;
an app server within the network operable to respond to input from a portable device;
where
the short range beacon is operable to transmit code enabling the portable device to execute the app;
the portable device is operable to monitor short range signals and further operable to execute the app if enabling code is received;
and where
the short range beacon is further operable to transmit code identifying the item of merchandise in association with which it is provided;
the portable device is operable to receive the merchandise identifying code and to pass the merchandise identifying code to the app server;
and
the app server is operable to obtain information concerning the identified merchandise and to provide interaction with the portable device.

16. The system of claim 15, wherein the short range beacon is also operable to transmit information relating to the location of the short range beacon; and wherein the app server is operable to store information concerning at least one of: the location of the short range beacon; and the merchandise identifying code.

17. The system of claim 15 wherein the merchandise is displayed in a display window.

18. The system of claim 15 wherein:
the short range beacon adapted to be provided in association with a plurality of items of merchandise on display;
and
the short range beacon is operable to transmit code identifying the each of the plurality of items of merchandise in association with which it is provided.

19. The system of claim 16 wherein:
the short range beacon adapted to be provided in association with a plurality of items of merchandise on display;
and
the short range beacon is operable to transmit code identifying the each of the plurality of items of merchandise in association with which it is provided.

20. The system of claim 15 wherein:
there are a plurality of short range beacons; and
the portable device is operable to receive the merchandise identifying codes from each of the plurality of short range beacons and to pass the merchandise identifying code to the app server.

21. The system of claim 16 wherein:
there are a plurality of short range beacons; and
the portable device is operable to receive the merchandise identifying codes from each of the plurality of short range beacons and to pass the merchandise identifying code to the app server.

22. The system of claim 17 wherein:
there are a plurality of short range beacons; and
the portable device is operable to receive the merchandise identifying codes from each of the plurality of short range beacons and to pass the merchandise identifying code to the app server.

23. The system of claim 18 wherein:
there are a plurality of short range beacons; and
the portable device is operable to receive the merchandise identifying codes from each of the plurality of short range beacons and to pass the merchandise identifying code to the app server.

24. The system of claim 19 wherein:
there are a plurality of short range beacons; and
the portable device is operable to receive the merchandise identifying codes from each of the plurality of short range beacons and to pass the merchandise identifying code to the app server.

25. The system of claim 18 wherein;
the app server is operable to provide to the portable device outlines of each of the plurality of items of merchandise in association with which the short range beacon is provided;
and
the portable device is operable to provide plural merchandise item selection indication to the app server.

26. The system of claim 19 wherein;
the app server is operable to provide to the portable device outlines of each of the plurality of items of merchandise in association with which the short range beacon is provided;
and
the portable device is operable to provide plural merchandise item selection indication to the app server.

27. The system of claim 20 wherein;
the app server is operable to provide to the portable device outlines of each of the plurality of items of merchandise in association with which the short range beacon is provided;
and
the portable device is operable to provide plural merchandise item selection indication to the app server.

28. The system of claim 21 wherein;
the app server is operable to provide to the portable device outlines of each of the plurality of items of merchandise in association with which the short range beacon is provided;
and
the portable device is operable to provide plural merchandise item selection indication to the app server.

29. The system of claim 22 wherein;
the app server is operable to provide to the portable device outlines of each of the plurality of items of merchandise in association with which the short range beacon is provided;
and
the portable device is operable to provide plural merchandise item selection indication to the app server.

30. The system of claim 23 wherein;
the app server is operable to provide to the portable device outlines of each of the plurality of items of merchandise in association with which the short range beacon is provided;
and
the portable device is operable to provide plural merchandise item selection indication to the app server.

31. The system of claim 24 wherein;
the app server is operable to provide to the portable device outlines of each of the plurality of items of merchandise in association with which the short range beacon is provided;
and
the portable device is operable to provide plural merchandise item selection indication to the app server.

32. A method comprising the steps of:
a step of providing a mannequin or portion of a mannequin fitted with a short range beacon in association with an item of merchandise on display;
a step of providing a network enabled portable device to receive signals from the short range beacon and to execute an app allowing network access;
a step of providing an app server within the network to respond to input from a portable device;
including the further steps
a step of the short range beacon transmitting code enabling the portable device to execute the app;
a step of the portable device monitoring the short range signals and executing the app if enabling code is received;
a step of the short range beacon transmitting code identifying the item of merchandise in association with which it is provided;
a step of the portable device receiving the merchandise identifying code and passing the merchandise identifying code to the app server;
and
a step of the app server obtaining information concerning the identified merchandise and providing interaction with the portable device.

33. The method of claim 32, including the steps of:
a step of the short range beacon transmitting information relating to the location of the short range beacon; and
a step of the app server storing information concerning at least one of: the location of the short range beacon; and the merchandise identifying code.

34. The method of claim 32 for use where the merchandise is displayed in a display window.

35. The method according to claim 32 including the steps of:
a step of providing the short range beacon in association with a plurality of items of merchandise on display;
and
a step of the short range beacon transmitting code identifying the each of the plurality of items of merchandise in association with which it is provided.

36. The method according to claim 33 including the steps of:
a step of providing the short range beacon in association with a plurality of items of merchandise on display;
and
a step of the short range beacon transmitting code identifying the each of the plurality of items of merchandise in association with which it is provided.

37. The method according to claim 34 including the steps of:
a step of providing the short range beacon in association with a plurality of items of merchandise on display;
and
a step of the short range beacon transmitting code identifying the each of the plurality of items of merchandise in association with which it is provided.

38. The method according to claim 32 including the steps of:
a step of providing a plurality of short range beacons; and
a step of the portable device receiving the merchandise identifying codes from each of the plurality of short range beacons; and
a step of the portable device passing the plurality of merchandise identifying codes to the app server.

39. The method according to claim 33 including the steps of:
a step of providing a plurality of short range beacons; and
a step of the portable device receiving the merchandise identifying codes from each of the plurality of short range beacons; and
a step of the portable device passing the plurality of merchandise identifying codes to the app server.

40. The method according to claim 34 including the steps of:
a step of providing a plurality of short range beacons; and
a step of the portable device receiving the merchandise identifying codes from each of the plurality of short range beacons; and
a step of the portable device passing the plurality of merchandise identifying codes to the app server.

41. The method according to claim 35 including the steps of:
a step of providing a plurality of short range beacons; and
a step of the portable device receiving the merchandise identifying codes from each of the plurality of short range beacons; and
a step of the portable device passing the plurality of merchandise identifying codes to the app server.

42. The method according to claim 36 including the steps of:
a step of providing a plurality of short range beacons; and
a step of the portable device receiving the merchandise identifying codes from each of the plurality of short range beacons; and
a step of the portable device passing the plurality of merchandise identifying codes to the app server.

43. The method according to claim 37 including the steps of:
a step of providing a plurality of short range beacons; and
a step of the portable device receiving the merchandise identifying codes from each of the plurality of short range beacons; and
a step of the portable device passing the plurality of merchandise identifying codes to the app server.

44. The method of claim 38 including the steps of:
a step of the app server providing to the portable device outlines of each of the plurality of items of merchandise in association with which the short range beacon is provided;
and
a step of the portable device providing merchandise item selection indication to the app server.

45. The method of claim 39 including the steps of:
a step of the app server providing to the portable device outlines of each of the plurality of items of merchandise in association with which the short range beacon is provided;
and
a step of the portable device providing merchandise item selection indication to the app server.

46. The method of claim 40 including the steps of:
a step of the app server providing to the portable device outlines of each of the plurality of items of merchandise in association with which the short range beacon is provided;
and
a step of the portable device providing merchandise item selection indication to the app server.

47. The method of claim 41 including the steps of:
a step of the app server providing to the portable device outlines of each of the plurality of items of merchandise in association with which the short range beacon is provided;
and
a step of the portable device providing merchandise item selection indication to the app server.

48. The method of claim 42 including the steps of:
a step of the app server providing to the portable device outlines of each of the plurality of items of merchandise in association with which the short range beacon is provided;
and
a step of the portable device providing merchandise item selection indication to the app server.

49. The method of claim 43 including the steps of:
a step of the app server providing to the portable device outlines of each of the plurality of items of merchandise in association with which the short range beacon is provided;
and
a step of the portable device providing merchandise item selection indication to the app server.
